(19) United States
(12) Patent Application Publication
(10) Pub. No.: US 2015/0178849 A1
(43) Pub. Date: Jun. 25, 2015

(54) SYSTEMS AND METHODS FOR CONSULTATIVE INSURANCE QUOTATIONS

(71) Applicant: The Travelers Indemnity Company, Hartford, CT (US)

(72) Inventors: Lee M. Berger, South Glastonbury, CT (US); Eulah Sheffield, Collinsville, CT (US); James J. Gauthier, JR., Avon, CT (US)

(21) Appl. No.: 14/133,894

(22) Filed: Dec. 19, 2013

(51) Int. Cl. G06Q 40/08

(52) U.S. Cl. CPC G06Q 40/08

(57) ABSTRACT

Exemplary embodiments provide systems, methods, and products that alter the content (e.g., the questions, information, advice, educational materials, and/or interface-page flow) experienced by each user of an automated insurance quotation system in order to create a consultative interaction with the user and to define an insurance product that fits the user's desires and requirements. Various embodiments determine the flow and content to present via the user interface to each user on the basis of information provided by the user throughout the computerized insurance consultation, quote, and purchase process. Some implementations may iteratively select specific content(s) from a set of content according to input or answers received from the user in response to previously presented content, and present the selected content(s) to the user.

### BACKGROUND

Since the introduction of online insurance quotes, the online purchase channel has—as a whole and across carriers—differentiated from “live channels” (e.g., local insurance agents, national call centers) by supporting a commoditized consumer value proposition focused on simplicity, speed, and price. Where the live channels often focus on counseling, education, and insurance needs analysis, their online counterpart has not participated as actively in that space; instead, messaging from the largest players in the online channel downplays the value of consultation by attempting to commoditize the insurance product.

Today, most insurance carriers have approached the online quoting/purchase capability with the goal of efficiently capturing data from prospective customers in order to quickly deliver a price (often a preliminary price which will be validated with additional data). This is executed through a standardized, largely invariable “interview” that is given to all users (e.g., potential customers) via the carrier's website, and that includes questions designed to gather the same specific set of information or data on various topics (information about the named insured, vehicles, drivers and their accident/incident/claim history, current insurance carrier and coverage, etc.) from each user. Some carriers' interviews provide default answers to certain questions, where the default is one of the most common answers to those questions. Others utilize data available from third party sources to pre-fill responses for users.

At the conclusion of the standardized interview, the websites of most carriers will present to the prospective customer quotes for one or more sets of proposed coverages, without specifically prompting the user for specific selections. From this quote view, users can typically edit the individual selections and self-personalize their quote, adding or removing optional coverages, changing coverage levels (limits and deductibles), and making other coverage choices. Typically, the proposed quotes will utilize the information provided by the user in the standardized interview, and perhaps information from other sources (e.g., third party data regarding automobile make and model) to develop the proposed set(s) of coverages. An example in the auto coverage area is to attempt to match the user's current Bodily Injury Liability coverage (obtained either in the interview as user-entered information, or purchased through a third party in a report commonly called “Insurance History”) with the same or similar Bodily Injury Liability coverage in the proposed set(s) of coverages for the new policy. Some carriers offer multiple coverage packages with the presentation of quotes, often presenting a standard package along with other pre-set package(s), (e.g., a package offering increased coverage, a package offering less coverage at a lower price).

Conventional interview websites provided by insurance carriers may display information text and value messaging (e.g., frequently asked questions, insurance terminology definitions, etc.) in addition to quote/purchase questions. But like the quote/purchase questions, the information text and value messaging does not vary from customer to customer, and the flow (e.g., the route or order of presentation) through the pages of the website does not vary from customer to customer. The flow, questions, and information are static, such that all users see the same thing.

To overcome many of the drawbacks of current, invariant, computerized insurance quotation systems, the present disclosure provides several useful and novel improvements, including systems, methods, and products for improved computerized and online insurance quotes and sales that dynamically tailor questions, content, messaging, and/or information to each individual user's needs according to user-descriptive information provided by the user and/or obtained from other sources in the course of interacting with the system.

### BRIEF DESCRIPTION OF THE DRAWINGS

The accompanying drawings, which are incorporated in and constitute a part of this specification, illustrate embodiments of the invention and together with the description, serve to explain the principles of the invention. Wherever convenient, the same reference numbers have been used to refer to the same or similar components. In the figures:

FIG. 1 is an example of a flow chart for consultative insurance quotations, consistent with embodiments of the invention;

FIG. 2A is a block diagram showing an example of a system for insurance coverage counseling and consulting, consistent with embodiments of the invention;

FIG. 2B is an example of a user interface with consultative content, consistent with embodiments of the invention;

FIG. 3A is a block diagram showing an example of a system for insurance coverage comparisons, presentation, and modification, consistent with embodiments of the invention;

FIG. 3B is an example of a user interface with consultative content and coverage comparison information, consistent with embodiments of the invention;

FIG. 4A is a swim lane chart showing an example of a system for insurance coverage counseling and consulting, consistent with embodiments of the invention;

FIG. 4B is an example of a user interface with consultative content and teaser information relevant to the user, consistent with embodiments of the invention;

FIG. 4C is an example of a user interface with consultative content, consistent with embodiments of the invention;

FIG. 4D is an example of a user interface with consultative content and another example of teaser information relevant to the user, consistent with embodiments of the invention; and

FIG. 5 is a block diagram of an exemplary computing system or data processing system that may be used to implement embodiments consistent with the invention.

### DETAILED DESCRIPTION OF EMBODIMENTS

In general, embodiments consistent with the present disclosure provide systems, methods, and products that reactively alter the questions, information, consultation, educational materials, and interface-page flow experienced by each user of an automated insurance quotation system in order to make the insurance product fit a user's desires and requirements and educate the user. Various embodiments consistent with this disclosure may dynamically determine the flow and content to present through the user interface to each user on the basis of information provided by the user throughout the computerized insurance consultation, quote, and purchase process.

Moreover, various embodiments consistent with the present disclosure provide a computerized, consultative insurance quote and purchase experience, for example, via an online website interface, that utilizes variable questioning, messaging, and counseling information to deliver content relevant to the user based on information collected previously in the interview, as well as, for some embodiments, based on information collected elsewhere (e.g., third party data, social media, transaction metadata, etc.). In some embodiments, the variable presentation of information may be rules-controlled, e.g., selected by a rules engine. In various embodiments, the consultative content may include content describing insurance coverage education and selection, savings opportunities, company and product explanations/differentiations, and broad quote/purchase considerations, and may mimic the value-add of live counselors, such as insurance agents or call center personnel. Thus, implementations of consultative content may include various forms of computer-presented advice to a user regarding choosing options, answering questions, and generally making decisions for purchasing insurance that is suitable for the user, via a computer interface, and broad advice and recommendations for selecting coverages and understanding the company providing the insurance.

Various embodiments consistent with the invention may enable the computerized (e.g., online) insurance channel to be more consistent with the offline insurance-purchase channels (e.g., local agents and national call centers) in terms of a value proposition focused on helping consumers through the process using consultation, rather than rushing them to a price, as well as the presentation of relevant information in the context of the broader, customized “insurance interview.”

Although the descriptions in this disclosure often use personal automobile insurance as an example, embodiments consistent with invention are not limited to personal automobile insurance and are equally applicable to other types of insurance, such as other personal insurance products (e.g., home, umbrella, personal articles floater, boat/yacht) and business insurance products (e.g., business owner policies (BOP), worker's compensation insurance (WC), etc.).

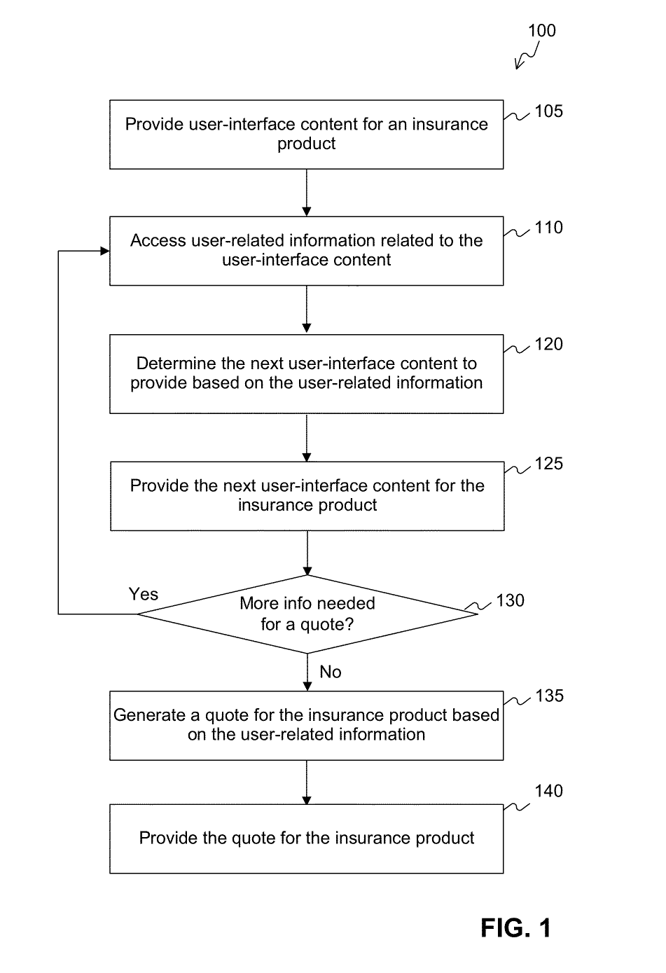

FIG. 1 is an example of a flow chart 100 for consultative insurance quotations, consistent with embodiments of the invention. In various embodiments, flow chart 100 may be implemented in hardware, software, or firmware. For example, flow chart 100 may be implemented by a server computer, such as a web server of an insurer, executing a software application or applications.

As shown in FIG. 1, flow chart 100 begins with providing (e.g., displaying) user-interface content for an insurance product (block 105) to a user. For conciseness and clarity of description, an entity that is engaged in purchasing an insurance product (i.e., a potential insured or a potential customer) may be referred to as a user or a customer, although the entity may not yet have completed the purchase transaction. The potential insured entity may be a person, corporation, partnership, non-profit organization, or other legal entity.

In various embodiments, the user-interface content may be query-related content (e.g., content presenting a query from the insurer seeking additional information from the user towards generation of a quote) and/or consultative content (e.g., content relating to advice given to a user, for instance, customized advice, recommendations, or other guidance that is based on the user's own characteristics). Such advice may include, for example, information related to one or more of: insurance coverage selections/levels, money-saving tips, or considerations that could impact shopping for or buying insurance, or information about the user's insurance company and/or current insurance policy, among other things. In various embodiments, the user-interface content may be provided in the form of text, graphics, sound, video, controls, and the like, as is known in the art of user interfaces for computers and computer applications. In various embodiments, the user-interface content may be componentized in the form of a web page, a frame, a pop-up window or pane, or the like, or a combination of more than one of these.

At block 110, the flow chart 100 continues by accessing (e.g., receiving or obtaining) user-related information associated with the user-interface content presented in block 105. In various embodiments, block 110 may access (e.g., receive) user-related information that comes from the user, such as information provided by the user when the user engages with controls presented on a graphical user interface, such as a push button, drop down menu, text box into which the user types information, or the like. In various embodiments, block 110 may access (e.g., obtain) user-related information from multiple sources, such as current interactions with the user-interface content, stored prior interactions with previously presented user-interface content, stored answers to prior questions, information obtained from nonpublic third party data sources, information gathered from public sources, such as social media, information from the technical interaction with the user's device, such as the user's browser type, IP address, the time of day, etc.

In various embodiments, accessing user-related information in block 110 by receiving such information and by obtaining such information may be carried out separately. For example, some components of user-related information may be received from a user in response to providing the user-interface content in block 105, while other components may be separately obtained in response to the received information.

In some embodiments related to auto insurance, accessing user-related information associated with the user-interface (110) may include receiving information relevant to the customer's automobile and coverage, such as information about the named insured, vehicles, drivers and their accident/incident/claim history, current insurance carrier and coverage, location, and/or other like information. For another example, in some embodiments related to business insurance, the user-related information accessed at block 110 may include information describing the customer's business operation, such as a business name, an address of the business, number of years in business, the identity of the legal entity being insured, type of business, and/or other like information.

At block 120, the flow chart 100 continues by determining the next user-interface content to provide to the user based on the user-related information accessed in block 110. In some embodiments, block 120 may be implemented using a rules-based system that selects the next user-interface content (e.g., consultative content) from among a set of componentized content according to the currently displayed user-interface content (block 105) and the user's input (block 110).

For example, in an online website implementation, for any given web page displayed at block 105, there may exist zero, one, or more options for consultation web pages offered, which would yield a secondary level of web page content once engaged. In such an implementation, determining of the next content to provide (e.g., consultative content to display) may be governed by a set of rules which may take into account factors such as: information previously disclosed by the user during the interaction with the website (e.g., state of residence, age of drivers, etc., entered in block 110); information about the user gathered from traditional insurance third-party data sources (e.g., insurance score information, vehicle information, etc., obtained by the system in block 110); information about the user gathered from other available public and/or private data sources (e.g., social media, Facebook profile, caller ID type reverse look-up, etc., obtained by the system in block 110); information about the technical interaction with the user (e.g., device/browser identity, machine identity, etc., recorded by the system in block 110); general information about the current interaction between the user and the website (e.g., time of day, day of week, etc., recorded by the system in block 110); internal insurance company information (e.g., availability of sales counselors to engage in calls, online chat, etc.). In some rules-based implementations, the rules that govern determination of the next user-interface content may be arranged in a hierarchy, for example, such that limitations may be placed on what is displayed to a user (e.g., a maximum of one informational message per page).

At block 125, the flow chart 100 provides (e.g., transmits for display) the next user-interface content for the insurance product, as determined at block 120. In various embodiments, the next user-interface content may be: content that allows the user to navigate to other content (e.g., a button control to generate a coverage recommendation or quote), content that is purely informational; content that enables access to additional information (e.g., a request or link to view third-party book value for the user's vehicle); content that requests additional information from the user for the purpose of delivering additional informational content (e.g., content that asks the user to input specific age groupings of children in their household); content that includes questions designed to begin selection of insurance coverages (e.g., accept or reject coverages, select coverage deductibles/limits, request quotes at multiple coverage levels, request quotes for additional lines of insurance, etc.); content that includes multiple levels of parent-child questions (e.g., if collision coverage is selected, present question(s) regarding deductible choice); and the like. Block 125 may also present no content at all, if that is what was prescribed by the determination function in block 120.

At block 130, the flowchart 100 determines whether more information is needed to provide a quote for insurance coverage. A quote is an estimated premium amount for the type of insurance coverage desired by a user. If more information is necessary to produce a quote, (block 130, Yes), then flow chart 100 loops back to block 110 to obtain additional user-related information. In various embodiments, the user-interface content for the insurance product (block 125) may include detailed questions, which the user answers (e.g., at block 110), and which are designed to gather all the information necessary to produce a quote. In various embodiments, the user's answers may be augmented with previously obtained user information (e.g., information previously entered by the user, information from third-party sources, etc.) to generate appropriate coverages and coverage levels for the user and a corresponding quote (e.g., at block 135).

If, on the other hand, no more information is necessary to produce a quote, (block 130, No), then flow chart 100 proceeds to block 135. At block 135, the flowchart 100 generates (e.g., calculates) a quote (or quotes) for the insurance product based on the user-related information. Next, at block 140, the flowchart 100 provides the quote for the insurance product, for example, by displaying the quote (or quotes) to the user or by transmitting the quote for display by a browser on the user's device. In various embodiments, blocks 135 and 140 may generate and present a quote or quotes for a predefined coverage package or packages. In some such embodiments, the user may customize or change the coverage package(s), perhaps according to advice or information provided by the user-interface content at blocks 105 and 125, and the flow chart 100 may generate (e.g., recalculate) a new rate quote for the insurance product (not shown in FIG. 1). In a further embodiment, the user may not be eligible to receive a quote, either online or at all, based on various underwriting and/or business guidelines. In those cases, the user may be presented not with a quote, but with a message indicating that a quote cannot be provided online.

Thus, various embodiments consistent with flowchart 100 bring expertise and consultation to the user of an automated insurance quotation system, such as a website, in a manner similar to a live conversation with a local insurance agent or a call center representative.

One of ordinary skill will recognize that blocks may be added to, deleted from, modified, or reordered in flow chart 100 without departing from the scope of the invention. For example, blocks 135 and 140 may be modified to present users with the options to (1) view a quote (as described previously), (2) select coverages/coverage levels for their quote before it is generated and provided, or (3) engage help to select coverages/coverage levels. In this modification, if the user selects the second option (i.e., to select their own coverages), the flowchart 100 may determine a coverage package for the user and present a web page customized to indicate a “starting point” that was selected based on what is known about the user from one or more iterations of blocks 110-130. From such a quote presentation page, the user may be prompted to customize/change coverages, in response to which the flowchart 100 may recalculate a new quote for the insurance product.

If the user selects the third option (i.e., engage help to select coverages), additional operations added to the flowchart 110 may support the election of optional coverages. Such operations may include providing consultative content to aid in the selection of coverage levels (e.g., limits, deductibles) within the context of providing education and information about the coverage type and customizing the coverage selections to the user's specific situation, based on the user's inputs and other user-related information. For content that is not required to generate a quote, the user may have the option to engage, or not to engage, with as much or as little of the consultative content as desired, including not engaging with any of the provided consultative content.

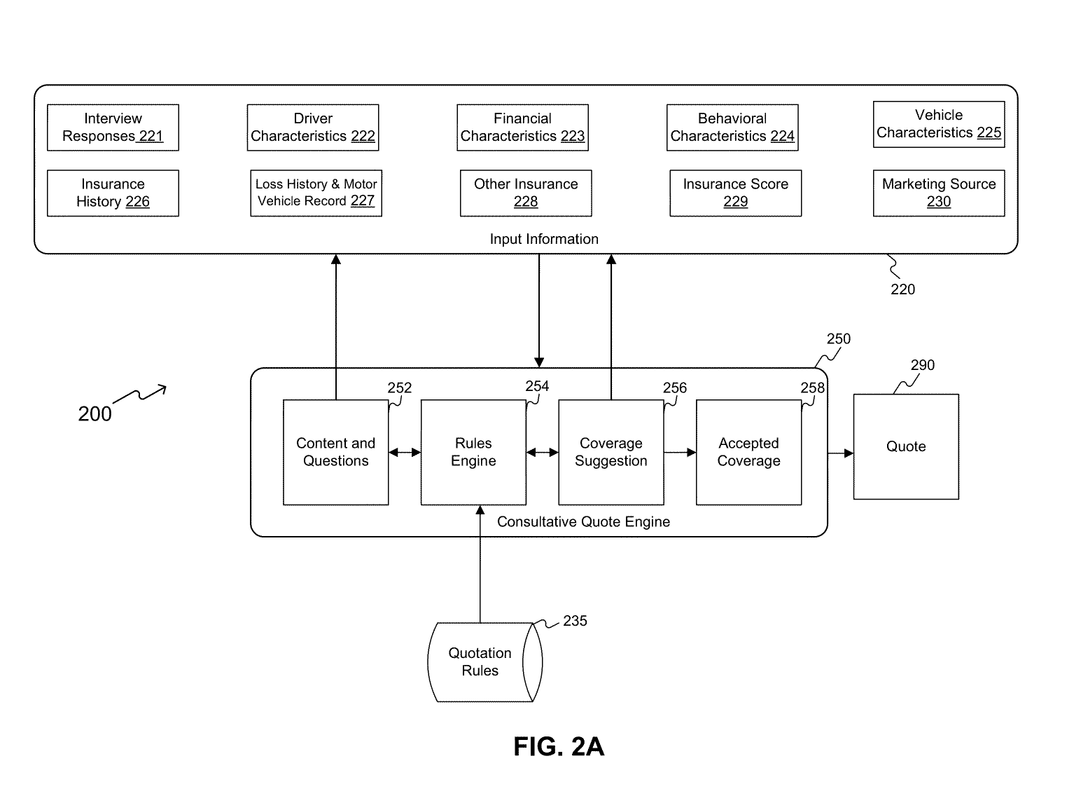

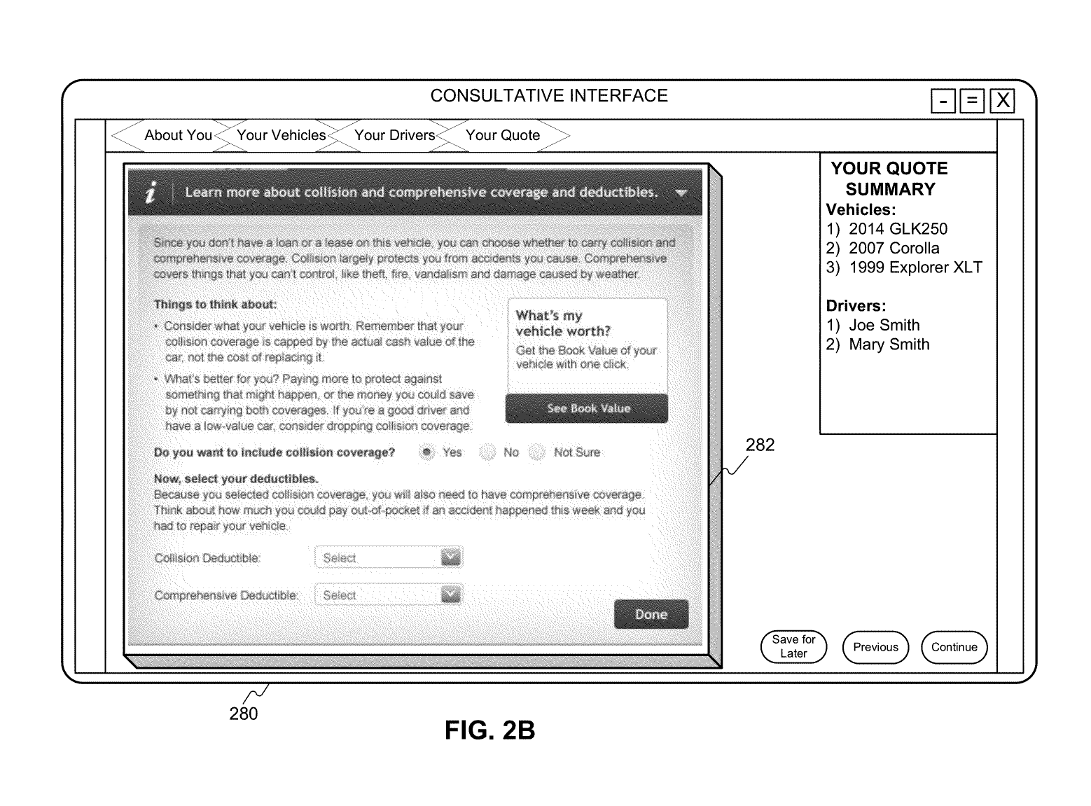

FIG. 2A is a block diagram of an exemplary system 200 for insurance coverage counseling and interactive consulting, consistent with embodiments of the invention. The example shown in FIG. 2A is an auto insurance consultative quote system 200 that includes a consultative quote engine 250 that receives input information 220 and uses quotation rules 235 to generate output data in the form of a quote 290 for an insurance product, which in this example is an auto insurance product or policy. In some embodiments, the input information 220 (or portions thereof) may correspond to the user-related information described in association with to FIG. 1.

In the embodiment shown in FIG. 2A, quotation rules 235 are the rules used by a rules engine 254 of the consultative quote engine 250 to determine the selection, order, and/or flow of the content and questions 252 presented to a user (for example, as described with respect to blocks 105-130 of FIG. 1) and to calculate or otherwise determine the quote 290 for an insurance product desired by the user (for example, as described with respect to blocks 135-140 of FIG. 1). In various embodiments, the quotation rules 235 may be implemented as code or statements executed or interpreted by the rules engine 254, which define, control, and/or constrain the coverage suggestions 256, the content and questions 252, and ultimately the quote 290, depending on and according to the input information 220, which may include various specific types of input information 221-230.

For example, the quotation rules 235 may contain a rule that specifies that if the user inputs information (e.g., via interview responses 221) indicating that he wishes to insure a car that is more than six years old, then the rules engine 254 should present content 252 to the user containing consultative information regarding not purchasing collision coverage for older cars in order to reduce the insurance premiums. Similarly in response to or association with this input, the quotation rules 235 may contain a rule that specifies that the rules engine 254 should also present content 252 to the user containing consultative information regarding the current market value of the car specified by the user, for example, as obtained from a third-party information source such as the Kelley Bluebook™ auto pricing service.

As shown in the example of FIG. 2A, the input information 220 to consultative quote engine 250 may include interview responses 221. In various embodiments, the interview responses 221 include information entered by a user, for example, in response to the content and questions 252 presented to the user, for example, via a browser that displays a web page from an auto insurance purchase website, via an interactive voice recognition subsystem, or some other user interface technology. In various implementations, the interview responses 221 may generally include information describing a vehicle that the user wishes to insure, the liability risks associated with the user, and other coverages desired by the user. More specifically, in various implementations, the consultative quote engine 250 may receive interview responses 221 that include some or all of the different examples of input information 222-230 shown in FIG. 2A.

In various embodiments, driver characteristics 222 may include information that describes or represents the user and/or driver(s) to be covered by an auto insurance policy desired by the user, such as gender, state licensed in, driving experience, marital status, name, address, primary residence, date of birth, email, phone number, and the like.

In various embodiments, financial characteristics 223 may include information that describes or represents the assets of the driver(s) to be covered by an auto insurance policy desired by the user, such as owned real estate value, liquid assets value, vehicle value, and the like. While these assets may not be specifically listed on a policy, the customer's assets may be a significant consideration in the selection or determination of, for example, appropriate limits of liability coverage, among other things, and as such, this information may be used by the consultative quote engine 250 to select and present specific content and questions 252 and generate coverage suggestions 256 and/or quotes 290.

In various embodiments, behavioral characteristics 224 may include information that describes or represents driving behaviors, such as whether the user drives in congested areas. While, in some embodiments, this behavior information may not be required to rate or issue auto insurance, it may be a significant consideration for the user in determining their risk factors and risk tolerance, which may be represented or manifested in an insurance policy selection(s) input by the user to the consultative quote engine 250, for example, in the form of coverage limits and/or deductibles.

In various embodiments, vehicle characteristics 225 may include information that describes or represents the automobile(s) to be covered by an auto insurance policy desired by the user, such as make, model, year, mileage, owned or leased, miles per year, usage type, garaging location, vehicle value, vehicle identification number, lien holder identification, and the like.

In various embodiments, insurance history 226 may include information that describes or represents a user's prior insurance company, prior liability limits, duration of continuous insurance, and the like.

In various embodiments, loss history and motor vehicle record 227 may include information that describes or represents previous claims or insurance-related events for the driver(s) to be covered by an auto insurance policy desired by the user, such as accident history, ticket history, claim history, motor vehicle incidents or violations, and the like.

In various embodiments, other insurance 228 may include information that describes or represents current insurance policies of the user or driver(s) to be covered by an auto insurance policy desired by the user, such as renter's insurance, umbrella insurance, homeowner's insurance, condo insurance, boat insurance, and the like.

In various embodiments, insurance score 229 may include information that describes or represents a risk prediction for the user, for example, in the form of a numerical point system based on selected credit report characteristics. In various embodiments, the insurance score may be used for underwriting decisions, and/or as a factor used by the consultative quote engine 250 in determining a premium amount in a quote 290.

In various embodiments, marketing source 230 may include information that describes or represents the entity, method, advertisement, or the like that directed, encouraged, instructed, focused, or otherwise guided the user to interact with the consultative quote engine 250. Examples of a marketing source 230 include a direct mail piece with the URL of a webpage that implements the consultative quote engine 250, a link, such as in an advertisement on a webpage, that directs the user to a webpage that implements the consultative quote engine 250, and the like. The quotation rules 235 and rules engine 254 may take the marketing source 230 into account when formulating coverage suggestions 256 and/or when choosing content and questions 252 to present to the user. For example, if the user was guided to the consultative quote engine 250 via a URL that was available only on direct mail pieces sent to a certain demographic (e.g., to people that own a single family dwelling), then the consultative quote engine 250 may present content and questions 252 and coverage suggestions 256 that are related to or relevant to that particular demographic (e.g., present optional content describing the advantages of bundling auto coverage with home owner's insurance coverage).

As noted above, in various embodiments, the input information 220-230 may be accessed from the user via interview responses 221 and/or may be accessed from other sources, including third-party sources or services, such as the Kelley Blue Book™ auto guide, Lexis-Nexis, Inc., Marshall & Swift/Boeckh, LLC, Insurance Services Office, Inc., Acxiom Corporation, or the like. In some embodiments, data from third-party sources or services may be used to pre-fill content presented to the user, such as web-page forms that have some or all fields already filled in when displayed on the user's browser. In some embodiments, input information 220 from third-party sources or services may be requested and gathered in real-time while the user is interacting with the system.

In the embodiment shown, the consultative quote engine 250 receives input information 220 and computes a set of zero or more quotes 290 based on the input information 220 that describe the risks and characteristics of the user, the vehicle, etc., that are relevant to the insurance product. In the embodiment shown, the consultative quote engine 250, in the process of generating a quote, may present or otherwise provide (e.g., send as a web page to a browser, present on the graphical user interface (GUI) of a standalone application, or the like) a set or series of content and questions 252 to the user, where the content and questions 252 are designed to elicit some or all of the input information 222-230 from the user via the interview responses 221. The exchanges of information between the consultative quote engine 250 and the user and/or one or more third parties are depicted in FIG. 2A by arrows. As noted previously, the set or series of content and questions 252 presented to the user may vary for each user according to the user's characteristics and their answers and reactions to previous questions and content. The consultative quote engine 250 may feed the input information 220 to the rules engine 254, which may determine the coverage suggestion(s) 256 to present or provide to the user.

In the embodiment shown, the consultative quote engine 250 includes a rules engine 254 (for example, implemented in software executing on a computing system), which performs calculations and determinations for controlling the flow and/or choice of content and questions 252 to present to the user (e.g., the order of web pages or windows displayed to a user and/or the query-related and/or consultative information making up or included in those web pages), for choosing coverage suggestion(s) 256 to present to the user, and for determining the quote 290 to present to the user. In the embodiment shown, some or all of these functions may be controlled by a set of quotation rules 235. In other embodiments, the consultative quote engine 250 may be implemented using techniques and technology that does not employ a rules engine 254, and quotation rules 235 may not be present in such embodiments. In non-rules embodiments, the functionality of quotation rules 235 may be incorporated directly into the program or digital logic, or other computation or determination techniques may be used. Other arrangements of hardware and/or software providing comparable results may also be used.

In various embodiments, the consultative quote engine 250 may be implemented to integrate information captured during the content and questions 252 “interview” interaction with the user (e.g., interview responses 221) or captured from other sources (e.g., third party sources providing insurance history 226 and the like) into the coverage suggestion or recommendation 256, which is presented to the user. For example, in various implementations, the consultative quote engine 250 may use information previously gathered from the interview responses 221 in its analysis and determination of the coverage suggestions 256, without asking the user for that information again (e.g., vehicle age, ownership status) at the time that the consultative quote engine 250 is ready to produce the coverage suggestions 256.

In various embodiments, the coverage suggestions 256 may include a recommendation(s) and/or educational information, which are types of consultative content, that are presented to the user to help them make a choice based on, for example, an expert set of considerations. For instance, FIG. 2B is an example of a user interface with educational consultative content, consistent with embodiments of the invention. As shown in FIG. 2B, coverage suggestions may be displayed on a user interface 280 that includes educational information and recommendations, for example, presented in a pop-up frame 282 that explains collision and comprehensive coverage concepts, and offers recommendations regarding how to choose deductibles.

Referring again to the example of FIG. 2A, after presenting the coverage suggestion 256 to the user, the consultative quote engine 250 may determine the accepted coverage(s) 258, according, for example, to choice(s) made by the user. The consultative quote engine 250 may then determine the quote(s) 290 that correspond to the accepted coverage 258.

In various implementations, the consultative quote engine 250 may engage a user who is interested in an auto insurance product with more than one interaction, each related to, for example, one or more of the user's vehicle, the user's liability, the user's other coverages, and the like. In various embodiments, each interaction may provide input information 220 related to the user's vehicle, the user's liability, and the user's other coverages, from the user and/or from other sources, such as third party sources.

One of ordinary skill will recognize that elements may be added to, removed from, or modified within system 200 without departing from the principles of the invention. For example, the coverage suggestion 256 and/or accepted coverage 258 may be removed, such that the consultative quote engine 250 generates the quote 290 for all possible coverages, or for a predetermined set of coverages.

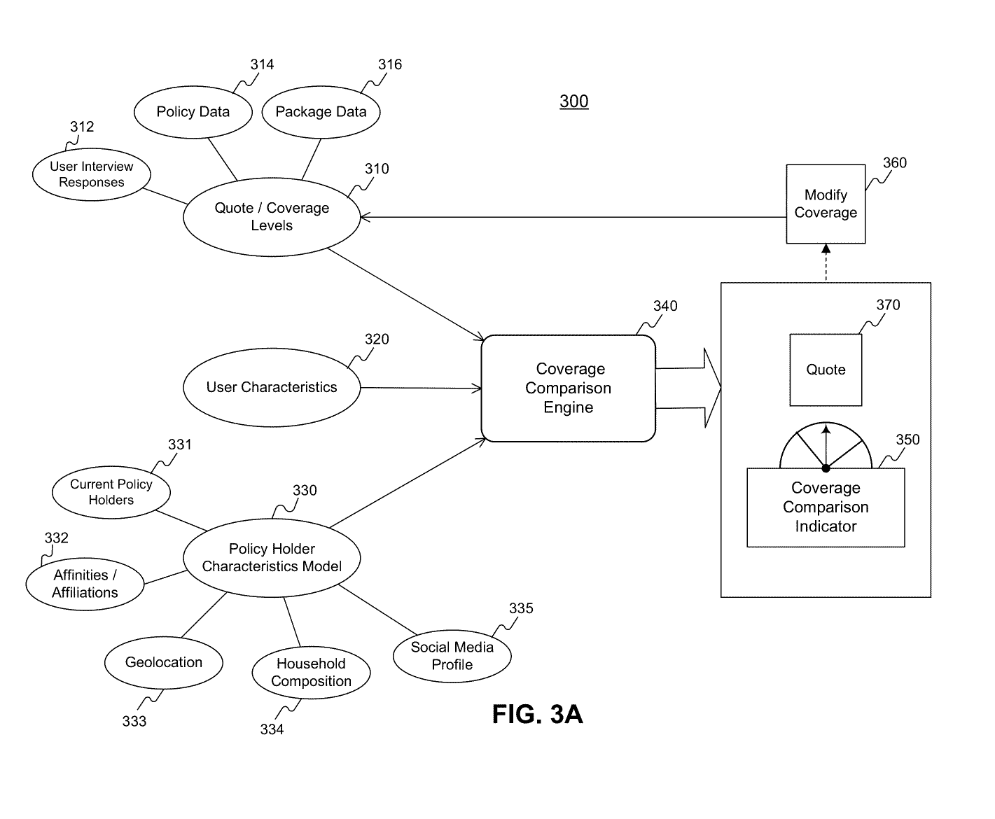

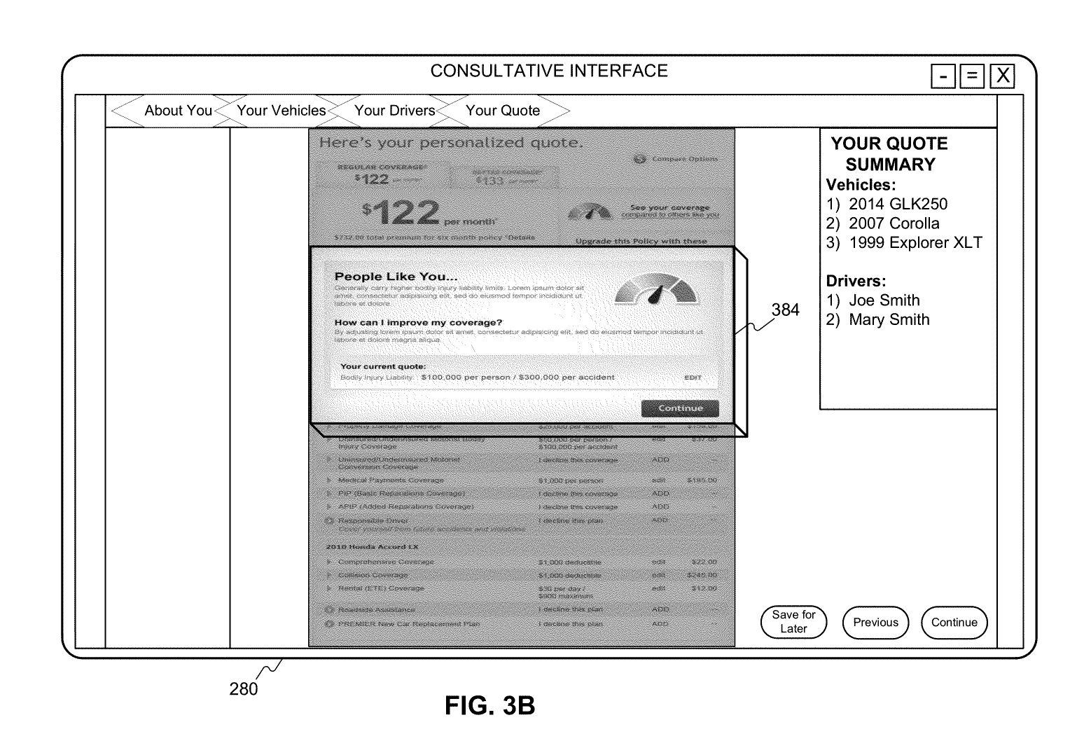

FIG. 3A is a block diagram showing an example of a system 300 for insurance coverage comparisons, presentation, and modification, consistent with embodiments of the invention. In some embodiments, the system 300 of FIG. 3A may be implemented as a subsystem or follow-on system to system 200 of FIG. 2A, such that after system 200 presents the quote 290 or as a part of presenting the quote 290, system 300 provides a coverage comparison as a form of additional counseling and consultation to the user.

As shown in FIG. 3A, the system 300 includes a coverage comparison engine 340 that receives or obtains inputs 310, 320, and 330 and generates as output a coverage comparison indicator 350. In various embodiments, after or in association with providing a quote 290 to a user (e.g., an auto insurance policy quote) from the consultative quote engine 250, the system 300 may generate and provide to the user the coverage comparison indicator 350, which in various embodiments may inform the user that other users that are similar (e.g., other insureds having similar characteristics and needs) purchased more insurance, less insurance, or approximately the same amount of insurance. In other words, the coverage comparison indicator 350 may signal whether similar users obtain more coverage, less coverage, or the same amount of coverage, which shows how the current user of system 300 measures in relation to his peers.

In the example shown in FIG. 3A, quote and coverage levels information 310 is an input to the coverage comparison engine 340. In various embodiments, the quote and coverage levels information 310 may include the quote 290 produced by the system 200 of FIG. 2A, which may be considered the insurance product desired by the current user. As shown in FIG. 3A, customer interview responses 312, policy data 314, and package data 316 may be part of the quote and coverage levels information 310. In various embodiments, the customer interview responses 312 and the policy data 314 may be as described with respect to FIG. 2A. The package data 316 may be a predetermined set of coverages selected for the user, a set of coverages influenced by prior interaction with the consultative content (for example as presented by the consultative quote engine 250), a user-self-selected set of coverages, any combination of these, or the like.

As shown in FIG. 3A, user characteristics information 320 is another example of an input to the coverage comparison engine 340. In various embodiments, the user characteristics information 320 may include information describing the user, such as the driver characteristics 222, the financial characteristics 223, the behavioral characteristics 224, etc., described with respect to FIG. 2A.

In the example shown in FIG. 3A, a policy holder characteristics model 330 is another input to the coverage comparison engine 340. In various embodiments, the policy holder characteristics model 330 may be built by data mining a set of auto insurance policies, such as the policies of current policy holders 331 of an insurance provider that is implementing system 300, to extract policy holder profiles. The policy holder characteristics model 330 may also be built using as inputs: affinities and affiliation information 332, geolocation information 333, household composition information 334, and/or social media profile information 335. The inputs 332-335 allow the building of a richer model with more variables to better differentiate and more accurately categorize users. Various embodiments may build a multivariate policy holder characteristics model 330 using a subset of the policy holder profiles and other information 332-335, and then use the entire set of auto insurance policy data to validate the multivariate model. This results in a predictive policy holder characteristics model 330 that can differentiate sets or groups of policy-holders and new customers from one another for coverage comparison purposes.

For example, the policy holder characteristics model 330 may have N different customer profiles, where N is greater than 1, and where each customer profile is characterized by the values of a set of, for example, five to ten variables that make up the model, and that have a high level of correspondence/predictability with respect to what coverage customers with that profile have purchased. Examples of such variables include age, income, level of previous insurance coverage, etc.

As shown in the example of FIG. 3A, the coverage comparison engine 340 may analyze (e.g., compare or match) the user characteristics 320 of a user with respect to the policy holder characteristics model 330 and place the user into one of the N different customer profiles, and then compare the coverage levels of a typical customer having the same customer profile as the user with the quote and coverage levels 310 selected by the user (e.g., using system 200). In other words, the coverage comparison engine 340 may access coverages chosen by already-insured customers who are similar to the user, and compare those coverages to the quote and coverage levels 310 selected by the user. Based on this comparison, the coverage comparison engine 340 may generate the coverage comparison indicator 350, which may inform the user whether he has more, less, or about the same coverage as current policy holders who have similar characteristics. In various embodiments, the coverage comparison indicator 350, in addition to or instead of reflecting more, less, or about the same coverage, may indicate which specific coverages are outside of the normal pattern. In various embodiments, the coverage comparison indicator 350 may present its indications in various graphical or textual formats, such as “Good/OK/Bad” categories, “green/yellow/red” color coding, a pointer on a slider graph, and/or a dial labeled “unsatisfactory” and “satisfactory” at the opposite ends, etc.

FIG. 3B is an example of a user interface with consultative content and coverage comparison information, consistent with embodiments of the invention. As shown in FIG. 3B, the coverage comparison indicator 350 may be displayed on a user interface 280 in a pop-up frame 384 that presents information comparing the user's chosen coverage to the coverage of other, similar insureds and offers recommendations regarding possible coverage changes for the user.

Returning again to the embodiment shown in FIG. 3A, the user may decide to modify their coverage 360 after considering the coverage comparison indicator 350, in which case the user's modified quote/coverage level information 310 is processed by the coverage comparison engine 340 of the system 300 to create a new quote 370 and/or coverage comparison indicator 350 that reflects the modified coverage chosen by the user. This modification cycle may repeat any number of times according to the desires of the user.

In various embodiments, the coverage comparison engine 340 may be implemented to integrate information captured in the interview responses 221 from the user during the content and questions 252 interaction into the coverage comparison indicator 350 and the interface for modifying coverage 360 that is presented to the user. For example, in various implementations, the coverage comparison engine 340 may provide dynamic paths for each user to modify coverage 360 based on coverage decisions that have already been made through interaction with the consultative quote engine 250 via interview responses 221 and the like. In one illustration, if a user has selected collision coverage during the quote interview interaction with the consultative quote engine 250, then the coverage comparison engine 340 may incorporate those previously made selections and give the user the opportunity to edit the selections, rather than requiring the user to answer the same questions again and reproduce previous selections.

One of ordinary skill will recognize that elements may be added to, removed from, or modified within system 300 without departing from the principles of the invention. For example, the elements of system 300 may be used in various combinations with the elements of system 200 to form a single system. In one example arrangement, the operations of system 300 are carried out in whole or in part in association with generating a quote 290.

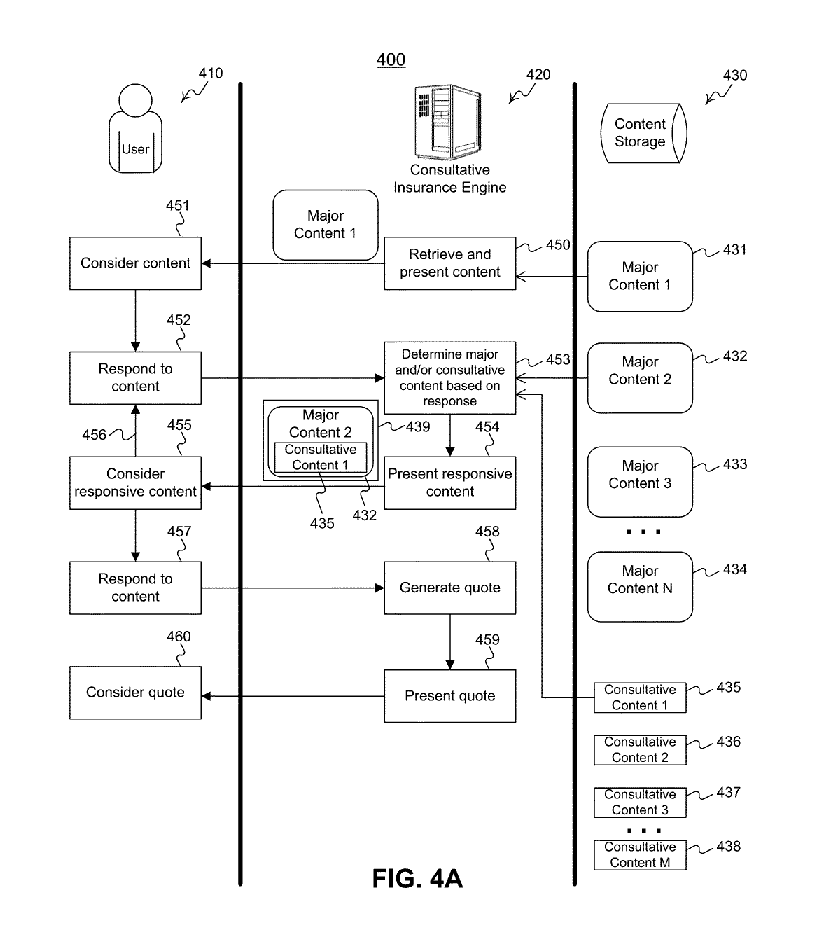

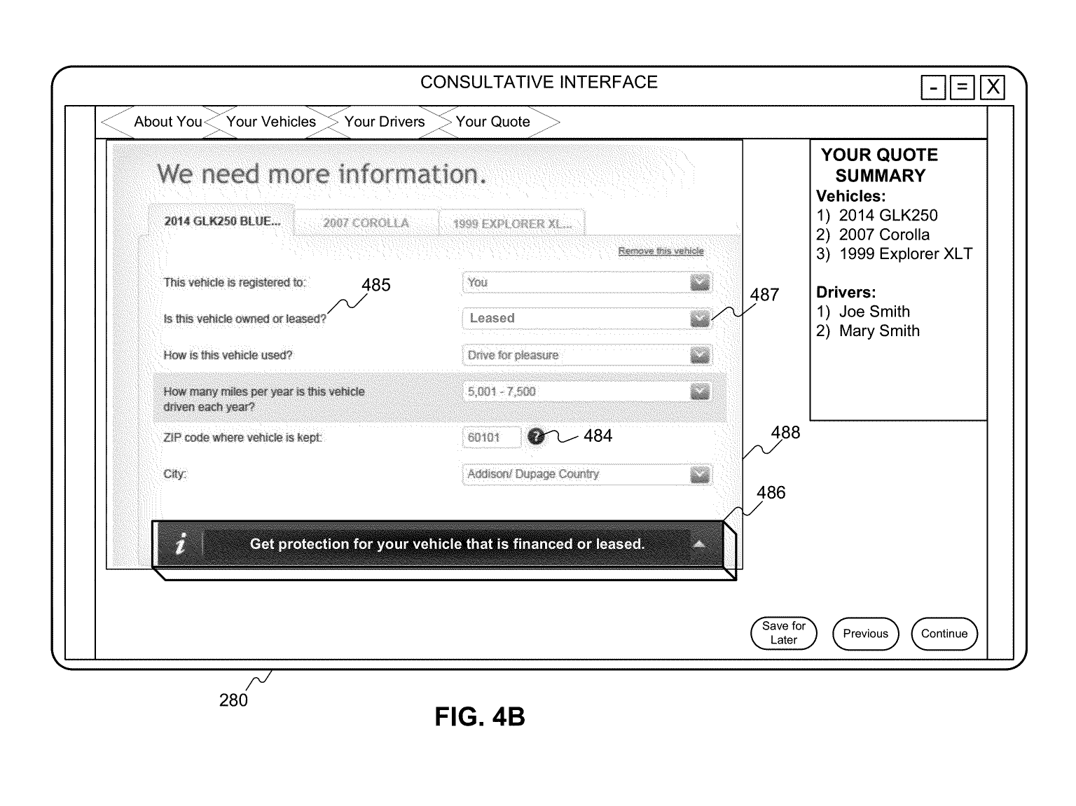

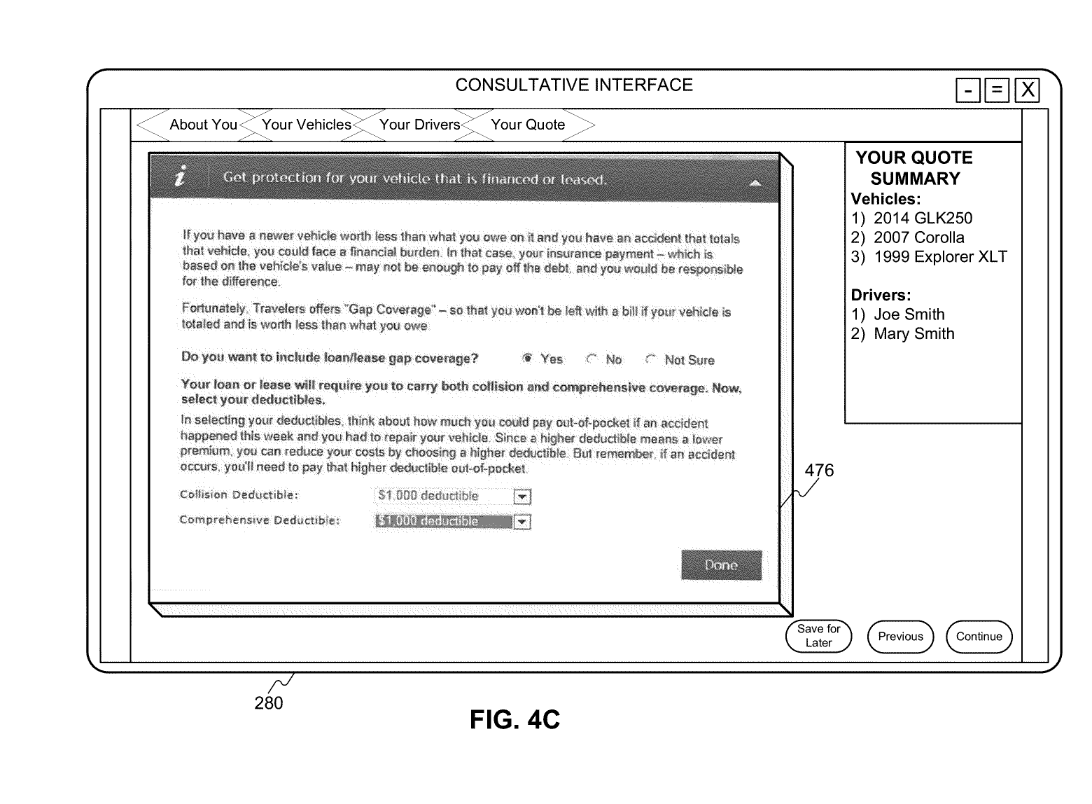

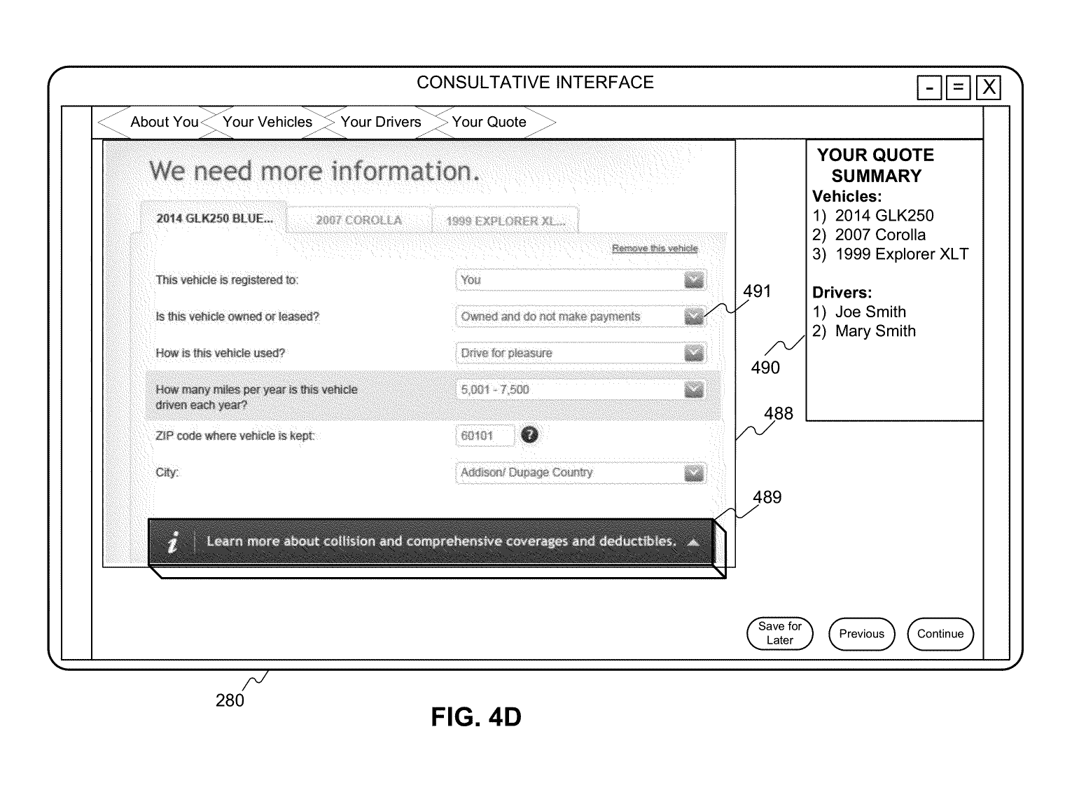

FIG. 4A is a swim lane chart 400 showing an example of a system for interactive insurance coverage counseling and consulting, consistent with embodiments of the invention. As shown, the left-hand column 410 shows the actions of a user, such a potential customer that is utilizing a website application or a standalone software application for the purpose of defining and purchasing an auto insurance product. The middle column 420 shows the actions, operations, functions, etc., of a consultative insurance engine, such as consultative quote engine 250 or coverage comparison engine 340, which may be implemented as part of a website application or a standalone software application. The rightmost column 430 represents a content storage containing content that may be retrieved, combined, and/or presented by the consultative engine represented in column 420.

In the embodiment shown, the content storage 430 contains major content 1 (431), major content 2 (432), major content 3 (433), and so on through major content “N” (434). In various embodiments, major contents 1 . . . N (431-434) may comprise query-related content, including web pages, GUI displays, text blocks, multimedia content, or the like containing, for example, fairly general or top-level insurance-related information and user-information-gathering capabilities, e.g., the capabilities provided by GUI tools, widgets, and controls, such as text-fill-in forms, selectable drop-down menus, selectable buttons, tool tips, and the like. In various embodiments, major contents 1 . . . N (431-434) (e.g., query-related content) may present, provide, and gather information that is needed by and from all or most users of the consultative insurance engine 420, such as name, address, description of the vehicle being insured, and the like. In various embodiments, the major contents 1 . . . N (431-434) may be content that is, in general, needed, or of interest, to many or most users 410, such as the content on the web pages of the primary flows through the consultative insurance engine 420 in a website or web application implementation.

In the embodiment shown, the content storage 430 also contains consultative content 1 (435), consultative content 2 (436), and so on through consultative content “M” (438). In various embodiments, consultative contents 1 . . . M (435-438) may be overlay web pages, overlay GUI displays, pop-up windows, in-line text boxes, or the like containing specific, specialized, particularized, and/or low-level insurance-related information and user-information-gathering GUI tools, widgets, and controls. In various embodiments, consultative contents 1 . . . M (435-438) may present and gather information that is typically needed by subsets, particular groups, or certain individual users of the consultative insurance engine, such as information describing insurance bundles for auto insurance buyers who also own a home, information about forgoing collision coverage for users owning older, non-valuable cars, information about additional umbrella policies for users having substantial financial assets, and other specialized information that is relevant only to subsets of the entire user community. In some embodiments, the consultative contents 1 . . . M (435-438) may present information that is primarily or completely optional with respect to the minimum information required to calculate or produce an insurance quote.

In various embodiments, the consultative contents 1 . . . M (435-438) may include additional information that is added or combined with major contents 1 . . . N (431 . . . 434), e.g., via a “teaser” line of copy or image, and that is exposed after a user 410 has demonstrated interest, for example by engaging with the controls offered by major contents 1 . . . N (431-434) to open a new webpage or an overlay (secondary level) that provides the consultative contents.

FIG. 4B is an example of a user interface that includes teaser information relevant to the user, consistent with embodiments of the invention. As shown in FIG. 4B, the user interface 280 may include major content 431-434 in major frame 488 and may include consultative content 435-438 in the form of a “teaser” link or other control, for example as a minor pop-up frame or control 486 that presents information, and/or a link to information, that is related to information that the user has previously entered. In the example shown in FIG. 4B, the pop-up control 486 states “Get protection for your vehicle that is financed or leased,” which the system selected for presentation to this user based on the user-entered information 487 “Leased” in response to the query 485 “Is this vehicle owned or leased?” If the user activates the pop-up control 486, the system may present to the user consultative content with information related to insuring cars that are financed or leased, for example, as described with respect to FIG. 4C below.

Also as shown in the example of FIG. 4B, the user interface 280 may include non-consultative query-related content, or a control that activates non-consultative query-related content, such as the question mark button 484, to present information that is not customized for a particular user or based on the inputs of a particular user, such as how to determine the correct “ZIP code where the vehicle is kept” to enter.

FIG. 4C is an example of a user interface with consultative content, consistent with embodiments of the invention. As noted above, the consultative content of FIG. 4C may be activated or displayed in response to a user's interaction with a teaser control, such as the pop-up control 486 of FIG. 4B.

In FIG. 4C, the system provides consultative content to the user via the user interface 280. In the example shown, educational information and recommendations related to protecting a vehicle that is financed or leased are displayed in a pop-up frame 476 that explains gap coverage and provides information related to the requirements for collision and comprehensive coverage for financed or leased vehicles, along with advice for choosing appropriate deductibles.

FIG. 4D is another example of a user interface with teaser information relevant to the user, consistent with embodiments of the invention. As shown in FIG. 4D, on a user interface 280, the major content 431-434 may be displayed in various major frames 488 and 490, and the consultative contents 1 . . . M (435-438) may be navigated to via a minor pop-up frame or control 489. In some embodiments, the consultative contents itself, rather than a navigation control leading to it, may be presented in a minor pop-up frame 489. In the example shown in FIG. 4D, the pop-up control 489 displays the text “Learn more about collision and comprehensive coverages and deductibles.” If the user activates the pop-up control 489, the system may present to the user consultative content with information about collision and comprehensive coverages and deductibles that were chosen, selected, or otherwise determined based on user-entered information, such as the user-entered information in major frame 488. For example, the system may select and present information about collision and comprehensive coverages and deductibles for cars that do not have a loan or lease, (for instance, as shown in pop-up frame 282 of FIG. 2B), based on the user-entered information 491 “Owned and do not make payments.”

In some embodiments, consultative contents 1 . . . M (435-438) may include information and additional questions that help a user understand various types of insurance coverages by directing an interactive “conversation” that suggests ways that a consumer may wish to think about specific coverages and whether or not the consumer should select each one. Examples include content having information about ways for the user to think about appropriate coverage levels (e.g., limits, deductibles) should they desire to purchase a particular type of coverage, and content having information regarding why a coverage recommendation may not be right for that consumer's particular situation and potential reasons why they may want to select different coverage options. Other examples include content describing discount opportunities, links to access outside information, (e.g., a link to view a third party's assessment of the user's vehicle's book value), content describing insurer and insurance product value (e.g., key features of the specific product and features that differentiate from other insurer's products), information describing considerations for selecting coverages and coverage levels, offers for alternate product quotes, and/or other value-add content.

Returning again to the implementation shown in FIG. 4A, the content storage 430 contains a set of componentized content, which can be dynamically selected through consultative insurance engine 420 and presented to a user 410 for engagement at the appropriate time in the user's interaction with the consultative insurance engine 420.

As shown near the top of column 420 in the example of FIG. 4A, the consultative insurance engine may retrieve content, such as major content no. 1 (431) from the content storage 430, and present (450) the content 431 to the user 410. In this example, the first instance of content presented to the user 410 is predetermined to be major content no. 1 (431), and this first content presented may be the same for all users. In a usage example, major content no. 1 (431) may be a vehicle-information-gathering web page that includes a form requesting the make, model, year, miles driven per year, owned or leased, etc., of the vehicle to be insured.

Upon receiving the major content no. 1 (431) from the consultative insurance engine 420, the user 410 considers the content 451. Continuing the above usage example, in a website implementation, the user 410 may consider the vehicle-information-gathering web page (e.g., major content no. 1 (431)) displayed on the user's browser.

Next, the user 410 may respond to the content 452. For example, the user 410 may enter information (e.g., via a text box) or manipulate controls (e.g., activate a push button, or make a selection from a drop-down menu). Continuing the previous usage example, the user 410 may enter into the web page form the make (e.g., Honda), model (e.g., Accord), year (e.g., 2012), miles driven per year (e.g., 12,000), owned or leased (e.g., leased), etc., for the car that the user wishes to insure.

Upon receiving the user's response, the consultative insurance engine 420 identifies or determines major and/or consultative content based on the user's response (453). In various embodiments, this operation may be implemented by a consultative quote engine 250 as described with respect to FIG. 2A. In the embodiment shown in FIG. 4A, the consultative insurance engine 420 may identify any of the major contents 1 . . . N (431-434) and/or the consultative contents 1 . . . M (435-438) according to program logic, rules, and/or circuit logic of the consultative insurance engine 420. In various embodiments, the consultative contents 1 . . . M (435-438) may be optional, and describe options for coverage available to the specific user 410. In general, the consultative insurance engine 420 may be designed to identify or determine the major contents 1 . . . N (431-434) and/or the consultative contents 1 . . . M (435-438) that provide information and/or further choices related to the last response provided by the user 410. Thus, the content, including the questions, presented to each user 410 varies dynamically according to the responses 452 provided by each user 410 to previous questions and content.

In the example shown in FIG. 4A, the consultative insurance engine 420 determines that a combination of major content no. 2 (432) and consultative content no. 1 (435) is the appropriate responsive presentation in accordance with the user's response 452, and the consultative insurance engine 420 presents this responsive content 454. In the example shown in FIG. 4A, the consultative insurance engine 420 creates a display 439 that shows major content no. 2 (432) as the primary information carrier, with consultative content no. 1 (435) as an inlaid frame combined inside major content no. 2. Many other variations are possible, as are known to those skilled in the user interface arts.

Continuing the usage example, the consultative insurance engine 420 may create a display 439 that shows major content 432 presenting a picture of the vehicle specified by the user along with the information typed in by the user, and that shows consultative content 435 presenting information about loan lease gap insurance, where the consultative insurance engine 420 identified consultative content 435 about loan lease gap insurance based on (e.g., in response to) the user's response at 452 indicating that his vehicle is leased. Conversely, if the user 410 had indicated at 452 that his vehicle is not leased and that he does not have a loan on the vehicle (e.g., an indication of “Owned and do not make payments,” as shown at 491 in FIG. 4D), then the consultative insurance engine 420 would not have identified consultative content 435 about loan lease gap insurance, and may have identified different, more relevant consultative content instead, because a user that does not lease his vehicle or have a loan on it would not be interested in purchasing loan lease gap coverage.

Upon receiving the display 439 from the consultative insurance engine 420, the user 410 considers the responsive content 455. As shown by arrow 456, the user 410 may next respond to the content 452 (e.g., respond to display 439) in a manner that causes the consultative insurance engine 420 to generate additional content and repeat 453-455. In various embodiments, operations 452-456 may be repeated several times as the consultative insurance engine 420 supplies and gathers sufficient information from the user 410 to generate a quote that is customized for the user. Alternatively, the user 410 may respond to the content at 457.

Continuing the usage example, the user 410 may respond 456 (or 457) to the consultative content 435 in the display 439 about loan lease gap insurance by indicating a desire to purchase this coverage for his leased Honda Accord.

As demonstrated with respect to 452-457 of FIG. 4, various embodiments as described extend the automated quote interview process beyond mere data collection to provide value through specific messaging and information gathering relevant to each particular user. For example, in various implementations, operations 453 and 454 may provide: (1) content regarding coverage selections and levels only and precisely at the relevant points in the interview interaction between the user 410 and the consultative insurance engine 420, (e.g., by selecting and presenting comprehensive and collision coverages when collecting information about vehicles); (2) money-saving tips content when appropriate triggering information is provided by the user 410; (3) content regarding considerations that impact selecting and buying insurance coverage (e.g., presence of young children in household); and/or (4) value information regarding the insurance company and/or the insurance product/policy when appropriate triggering information is provided by the user 410 (e.g., present content describing claim handling ease and expertise when a user indicates they have had accidents or claims in the past).

As also demonstrated with respect to 452-457 of FIG. 4, various embodiments may be implemented to emphasize the importance of understanding various coverages with respect to each individual user's situation. For example, in various implementations, operations 453 and 454 may provide (1) content with guidance regarding how to decide and what to consider in selecting optional coverages (e.g., consider actual cash value of vehicle in determining whether to include comprehensive and collision coverages); (2) content with guidance regarding how a consumer should determine their appropriate coverage levels (e.g., calculate potential assets at risk in event of a liability judgment); and/or (3) content with information to assist a consumer in understanding whether the coverage recommendation that was provided is right for them, and the reasons they may elect to disregard the recommendation and choose more or less coverage (e.g., users with limited assets, but who are worried about protecting future earnings may elect to increase liability coverages above the recommended amount).

After one or more iterations through 452-456, the user 410 may finish the information phase and may respond to the content (e.g., to display 439) in a manner that causes the consultative insurance engine 420 to generate (e.g., calculate) a quote 458, as represented by the action to respond to content 457. In various embodiments, the quote generated at operation 458 may be as described with respect to the quote 290 of FIG. 2A. The consultative insurance engine 420 may next present the calculated quote 459, and the user 410 may then consider the quote 460.

Concluding the usage example, the consultative insurance engine 420 may calculate 458 and present 459 a quote that includes not only standard collision and comprehensive coverage for the Honda Accord, but also includes loan lease gap insurance for the leased Honda Accord. Thus, various embodiments consistent with this disclosure provide expertise and counseling in a manner that is customized to the user 410 during the quote interview process 450-457 through content 431-438 that is selected and tailored for each individual user 410.

One of ordinary skill will recognize that elements may be added to, removed from, or modified within the system of FIG. 4A without departing from the principles of the invention. For example, additional operations may be added to present a set of user-selectable coverages before generating or calculating a quote. For another example, additional operations may be added to present coverage comparison information with respect to similarly situated users and allow a user to modify their coverage after the comparison.

For yet another example, operations may be added such that the consultative insurance engine 420 identifies the marketing source (e.g., a direct mail piece, a search engine link, etc.) that led the user 410 to interact with the consultative insurance engine 420 and identifies or determines consultative content (453) based in part on the marketing source. For instance, an insurer may send out a direct mail piece to members of a defined demographic group, such as members of the American Association of Retired Persons™, and a member of that group may interact with the consultative insurance engine 420, e.g., through a webpage URL supplied with the direct mail piece. In this example, based on the URL, the consultative insurance engine 420 may determine that the user is a member of a specific demographic group and choose specific major content 431-434 and/or consultative content 435-438 that are designed to impart information and/or questions for that specific demographic group (e.g., the retired persons demographic group).

For yet another example, operations may be added for the consultative insurance engine 420 to store information provided during the quote and purchase interaction with the user 410, and to use the stored information for future contacts with the user 410. For instance, where an online quote (or partial quote) is saved and retrieved online, or a quote is completed (or partially completed) online and subsequently the user 410 calls a call center, that web quote may be retrieved and used during the call. In the latter case, the company representative receiving the call may have available not just the quote data that was completed, but information regarding what content from content storage 430 was presented to the user 410, how various questions were answered, and what coverage suggestions and quote(s) were presented to the user 410 by the consultative insurance engine 420.

In yet another implementation consistent with the invention, a computer-implemented method (not shown) for consultative insurance quoting may provide to a user with a first type of content related to an insurance product, such as major content 431-434, for example via a local or remote GUI. The computer (e.g., computing system 500) may then receive, from the user, first information responsive to the first content, such as any of the input information 220. The computer may then determine, based on the first information from the user responsive to the first content, second content related to the insurance product, such as consultative content 435-438. In various implementations, the second content may include query-related content and consultative content. Next, the computer may provide, to the user, the second content related to the insurance product, for example by displaying, audibly playing, etc., the second content via a GUI. Then, the computer may receive, from the user, second information responsive to the second content. For example, the second information may be any of the input information 220. The computer may then generate a quote for the insurance product (e.g., quote 290) that is customized according to at least one of the first information and the second information. The computer may also provide the quote for the insurance product to the user, for example, via a GUI. The computer may also determine what second to provide to the user by selecting second content that corresponds to the first information received from the user, for example, second content that is chosen based on the user's response to the first content.

In some variations of this implementation, the computer may also determine a set of insurance-product coverages for the user that correspond to the quote, compare the set of insurance-product coverages for the user to insurance-product coverages purchased previously by customers having characteristics substantially the same as characteristics of the user to produce a coverage comparison indicator, such as a coverage comparison indicator 350, and provide the coverage comparison indicator to the user, for example via a pop-up frame 384 on a GUI.

In some variations of these implementations, the first content related to the insurance product may include a question regarding a characteristic of the user that is relevant to the insurance product (e.g. content and questions 252), and the first information responsive to the first content may include an answer to that question, from the user (e.g., any of the input information 220). Similarly, in some variations, the second content related to the insurance product may include a second question regarding a second characteristic that is relevant to the insurance product, and the second information responsive to the second content may include an answer to that second question. In some variations, the second content related to the insurance product may include content that describes a coverage option for the insurance product. In some variations, the second content related to the insurance product may be determined by selecting the second content from a set of componentized contents, for example, a previously defined and stored set of pop-up frames.

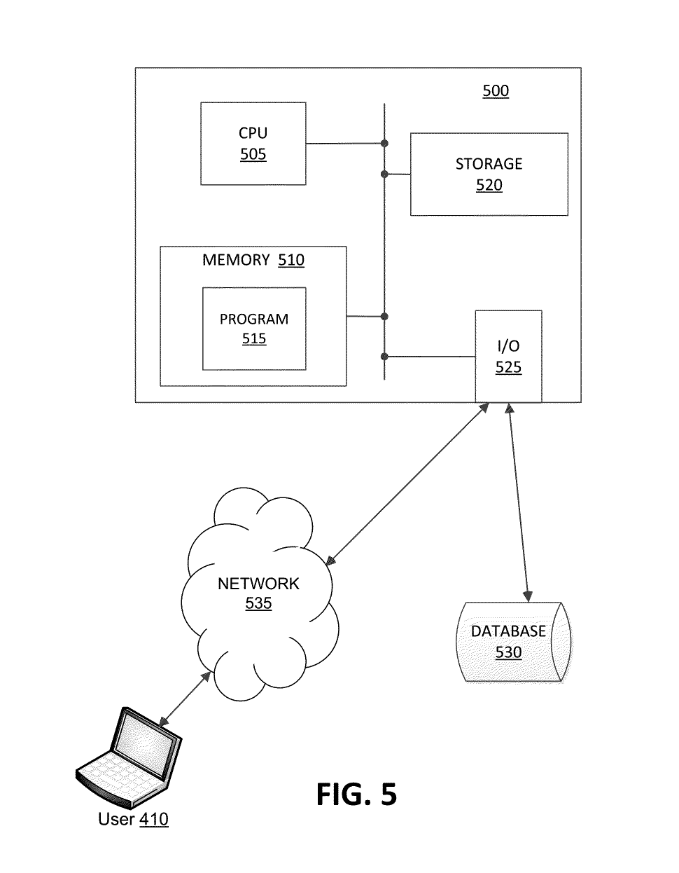

FIG. 5 is a block diagram of an exemplary computing system or data processing system 500 that may be used to implement embodiments consistent with the invention. Other components and/or arrangements may also be used. In some embodiments, computing system 500 may be used to implement a consultative insurance quotation system, for example, either stand alone or as part of a larger insurance quotation system. In various embodiments, computing system 500 may be used to implement engines implementing functionality associated with consultative insurance quotations, such as the consultative quote engine 250 of FIG. 2A, the coverage comparison engine 340 of FIG. 3, and the consultative insurance engine 420 of FIG. 4. In various embodiments, computing system 500 may be used to implement methods, processes and operations for consultative insurance quoting, as described herein.

Computing system 500 includes a number of components, such as a central processing unit (CPU) 505, a memory 510, an input/output (I/O) device(s) 525, and a nonvolatile storage device 520. System 500 can be implemented in various ways. For example, an implementation as an integrated platform (such as a workstation, server, personal computer, tablet computer, laptop, smart phone, etc.) may include CPU 505, memory 510, nonvolatile storage 520, and I/O devices 525. In such a configuration, components 505, 510, 520, and 525 may connect and communicate through a local data bus and may access a database (implemented, for example, as a separate database system) via an external I/O connection. I/O component(s) 525 may connect to external devices through a direct communication link (e.g., a hardwired or local Wi-Fi connection), through a network, such as a local area network (LAN) or a wide area network (WAN), and/or through other suitable connections. System 500 may be standalone or it may be a subsystem of a larger system.

CPU 505 may be one or more known processing devices, such as a microprocessor from the Core™ family manufactured by the Intel™ Corporation of Santa Clara, Calif., or the like. Memory 510 may be one or more solid-state storage devices or mediums configured to store instructions and information used by CPU 505 to perform certain functions, methods, flowchart operations, and processes related to embodiments of the present invention. Storage 520 may be a volatile or non-volatile, magnetic, semiconductor, tape, optical, or other type of storage device or computer-readable storage medium, including devices such as CDs and DVDs, meant for long-term storage. The storage device 520 depicted in FIG. 5 is representative of a class and/or subset of computer-readable media that are defined herein as “computer-readable memory” (e.g., non-transitory memory devices as opposed to transmission devices or media).

In the illustrated embodiment, memory 510 contains one or more programs or subprograms 515 loaded from storage 520 or from a remote system (not shown) that, when executed by CPU 505, perform various operations, procedures, functions, processes, or methods consistent with the present invention. Alternatively, CPU 505 may execute one or more programs located remotely from system 500. For example, system 500 may access one or more remote programs via network 535 that, when executed, perform functions and processes related to or implementing embodiments of the present invention.

In one embodiment, memory 510 may include a program(s) 515 that implements a consultative insurance quotation system, such as a program that implements flowchart 100, consultative quote engine 250, and/or consultative insurance engine 420 and content storage 430. In some embodiments, memory 510 may also include other programs or applications that implement other methods and processes that provide ancillary functionality to the invention. For example, memory 510 may include programs that gather from various sources, organize, store, and/or generate the input data 220 used by the consultative quote engine 250.

Memory 510 may be also be configured with other programs (not shown) unrelated to the invention and/or an operating system (not shown) that performs several functions well known in the art when executed by CPU 505. By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to the invention.

I/O device(s) 525 may include one or more input/output devices that allow data to be received and/or transmitted by system 500. For example, I/O device 525 may include one or more input devices, such as a keyboard, touch screen, mouse, and the like, that enable data to be input from a user, such as a customer 120 or an agent working with the customer 120. Further, I/O device 525 may include one or more output devices, such as a display screen, CRT monitor, LCD monitor, plasma display, printer, speaker devices, and the like, that enable data to be output or presented to a user. I/O device 525 may also include one or more digital and/or analog communication input/output devices that allow computing system 500 to communicate, for example, digitally, with other machines and devices, for example, when computing system 500 is acting as a web server. Other configurations and/or numbers of input and/or output devices may be incorporated in I/O device 525.

In the embodiment shown, system 500 is connected to a network 535 (such as the Internet, a private network, a virtual private network, or other network), which may in turn be connected to various systems (e.g., third party data provider servers) and computing machines, such as a desktop computer, smart phone, tablet computer or laptop computer of a user 410 who wishes to utilize system 500. In general, system 500 may input data from external machines and devices and output data to external machines and devices via network 535.

A database 530 may also be used in conjunction with system 500. In the embodiment shown, a standalone database external to system 500 may be used. In other embodiments, a database may be hosted by system 500. The database may be used to manage and store data used to implement systems and methods consistent with the invention. For example, the database 530 may implement content storage 430 of FIG. 4, managing and storing data structures that contain content that is presented to users, such as the user 410. For another example, the database 530 may contain input data 220 previously entered by a user, the quotation rules 235, and other information used by the consultative quote engine 250. In general, the database 530 may store information that is accessed and/or managed through system 500. By way of example, such a database may be an Oracle™ database, a Sybase™ database, or other relational database. Systems and methods consistent with the invention, however, are not limited to separate data structures or databases, or even to the use of a database or data structure.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may include one or more communication or network components. As used herein, a “user” may generally refer to any individual and/or entity that operates a user device. Users may include, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that include a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may include or be computers, such as those based on the Intel® Pentium® or Centrino™ processor, that are adapted to communicate with the computer. Any number and type of machines may be in communication with the computer.

It will be apparent to those skilled in the art that various modifications and variations can be made to the structures and methodologies described herein. Thus, it should be understood that the invention is not limited to the examples discussed in the specification. Rather, the present invention is intended to cover modifications and variations.

What is claimed is:

1. A system for consultative insurance quoting, the system comprising:
a memory containing instructions; and
a processor, operably connected to the memory, that executes the instructions to perform operations comprising:
providing, to a user, first content related to an insurance product;
receiving, from the user, first information responsive to the first content;
determining, based on the first information from the user responsive to the first content, second content related to the insurance product, wherein the second content comprises query-related content and consultative content;
providing, to the user, the second content related to the insurance product;
receiving, from the user, second information responsive to the second content; and
generating a quote for the insurance product that is customized according to at least one of the first information and the second information.

2. The system of claim 1, the operations further comprising:
providing the quote for the insurance product to the user.

3. The system of claim 1, wherein the first content related to the insurance product comprises:
content that includes a question regarding a characteristic of the user that is relevant to the insurance product; and
wherein the first information responsive to the first content comprises:
an answer to the question from the user.

4. The system of claim 1, wherein the second content related to the insurance product comprises:
content that includes a second question regarding a second characteristic that is relevant to the insurance product; and
wherein the second information responsive to the second content comprises:
an answer to the second question.

5. The system of claim 1, wherein determining the second content related to the insurance product comprises:
selecting the second content from a set of componentized contents.

6. The system of claim 1, wherein determining the second content related to the insurance product comprises:
selecting the second content that corresponds to the first information from the user.

7. The system of claim 6, wherein the second content related to the insurance product comprises:
content that describes a coverage option for the insurance product.

8. The system of claim 1, the operations further comprising:
determining a set of insurance-product coverages for the user that correspond to the quote;
comparing the set of insurance-product coverages for the user to insurance-product coverages purchased previously by customers having characteristics substantially the same as characteristics of the user to produce a coverage comparison indicator; and
providing the coverage comparison indicator to the user.

9. A non-transitory computer readable medium including instructions that, when executed by a processor, perform operations for consultative insurance quoting, the operations comprising:
providing to a user first content related to an insurance product;
receiving, from the user, first information responsive to the first content;
determining, based on the first information from the user responsive to the first content, second content related to the insurance product, wherein the second content comprises query-related content and consultative content;
providing, to the user, the second content related to the insurance product;
receiving, from the user, second information responsive to the second content; and
generating a quote for the insurance product that is customized according to at least one of the first information and the second information.

10. The non-transitory computer readable medium of claim 9, the operations further comprising:
providing the quote for the insurance product to the user.

11. The non-transitory computer readable medium of claim 9, wherein the first content related to the insurance product comprises:
content that includes a question regarding a characteristic of the user that is relevant to the insurance product; and
wherein the first information responsive to the first content comprises:
an answer to the question from the user.

12. The non-transitory computer readable medium of claim 9, wherein the second content related to the insurance product comprises:
content that includes a second question regarding a second characteristic that is relevant to the insurance product; and
wherein the second information responsive to the second content comprises:
an answer to the second question.

13. The non-transitory computer readable medium of claim 9, wherein determining the second content related to the insurance product comprises:
selecting the second content that corresponds to the first information from the user.

14. The non-transitory computer readable medium of claim 9, the operations further comprising:
determining a set of insurance-product coverages for the user that correspond to the quote;
comparing the set of insurance-product coverages for the user to insurance-product coverages purchased previously by customers having characteristics substantially the same as characteristics of the user to produce a coverage comparison indicator; and
providing the coverage comparison indicator to the user.

15. The non-transitory computer readable medium of claim 9, wherein determining the second content related to the insurance product comprises:
selecting the second content from a set of componentized contents.

16. The non-transitory computer readable medium of claim 9, wherein the second content related to the insurance product comprises:
content that describes a coverage option for the insurance product.
